(19) United States
(12) Patent Application Publication
(10) Pub. No.: US 2002/0112995 A1
(43) Pub. Date: Aug. 22, 2002

(54) Pin hole detection system

(76) Inventor: Edward P. Hess, Glen Ellyn, IL (US)

Correspondence Address: Niro, Scavone, Haller & Niro, 181 W. Madison-Suite 4600, Chicago, IL, 60602, US

(21) Appl. No.: 09/969,014

(22) Filed: Oct. 2, 2001

Related U.S. Application Data
(60) Provisional application No. 60/255,711, filed on Dec. 14, 2000.

(51) Int. Cl. B07C 5/00

(52) U.S. Cl. 209/509

(57) ABSTRACT

The present invention concerns a part detection system and related method of inspecting a part. The device includes a base defining a cavity and a support which operates in conjunction with said the base. The support retains a part thereon in a spaced apart relationship. A light source is positioned adjacent to the support so as to illuminate the part. If the part contains a flaw, the light will pass through it and be detected by sensors located in the base or elsewhere to indicate a flaw in the part.

This application claims priority to U.S. Provisional Patent Application No. 60/255,711, filed Dec. 14, 2000.

### BACKGROUND OF THE INVENTION

The present invention concerns a method and apparatus for conveying a piece part such as an automotive door panel along an assembly line or conveyor system. The present invention also concerns a method and apparatus for checking the piece part for pin holes, tears, rips, and other aberrations or imperfections/flaws in the integrity of the part.

### SUMMARY OF THE INVENTION

The present invention enhances the operation of an assembly line by providing a base which includes a releasably mounted buck, top portion, or support which is molded to fit the contours of a piece part. Configuring the support in this manner positively retains the part by multiple points of contact. This inhibits movement of the part in multiple directions. In addition, the contoured support functions as a guide which allows an operator to quickly and easily mount the part onto the device for transport within the conveyor system. The support may be made by vacuum forming.

To detect the presence of unwanted holes or breaks (imperfections) in the part, the present invention provides a single light source or a plurality of light sources. Also provided is a sensor or a plurality of sensors or cameras which are located in a cavity of a light proof enclosure or base.

Placed over the top of the enclosure is a buck which may be clear or translucent and which is adapted to permit light to pass through it. Placed between the part and the buck are a plurality of spacers or seals which assist in holding the part a spaced distance apart from the buck to form a gap. The seals may also be used to mask or block off holes or openings in the part.

The part is positioned under a light source which is activated. If an unwanted aperture, flaw or break is present in the part, light will pass through the opening and strike the support. This will cause an illumination point to appear on the support which will be detected by a sensor which is an indication of a faulty part. Multiple light sources may also be used. When this is done, light will travel through the opening or aperture at various angles and strike and illuminate the support at various points. This provides a larger zone or multiple zones of illumination for detection by a sensor. Providing a gap also allows for the light to be diffused through the imperfection to also create a larger zone of illumination than the actual size of the aberration or flaw in the part. This is particularly helpful in detecting small pin holes since, without the expanded zone of illumination, the area of illumination created by smaller pin holes may escape detection by the sensors.

### DESCRIPTION OF THE DRAWINGS

These and other features, objects and advantages of the present invention will become apparent from the following description and drawings wherein like reference numerals represent like elements in several views, and in which:

FIG. 1 is a perspective view of one embodiment of the present invention as used in an assembly line operation.

FIG. 2 is a perspective view with portions removed to reveal aspects of the invention.

FIG. 3 is a partial cross-section view of the embodiment shown in FIG. 2 taken along line 3-3.

FIG. 4 is a partial front view illustrating an imperfection in a part.

FIG. 5 illustrates how multiple light sources create a widespread detection pattern.

FIG. 6 is a view of the read outs which may be used with the present invention.

FIG. 7 illustrates how multiple light sources create a widespread detection pattern.

### DESCRIPTION OF THE PREFERRED EMBODIMENT

Set forth below is a description of what are currently believed to be the preferred embodiments or best examples of the invention claimed. Future and present alternatives and modifications to the preferred embodiments are contemplated. Any alternates or modifications in which insubstantial changes in function, in purpose, in structure or in result are intended to be covered by the claims of this patent.

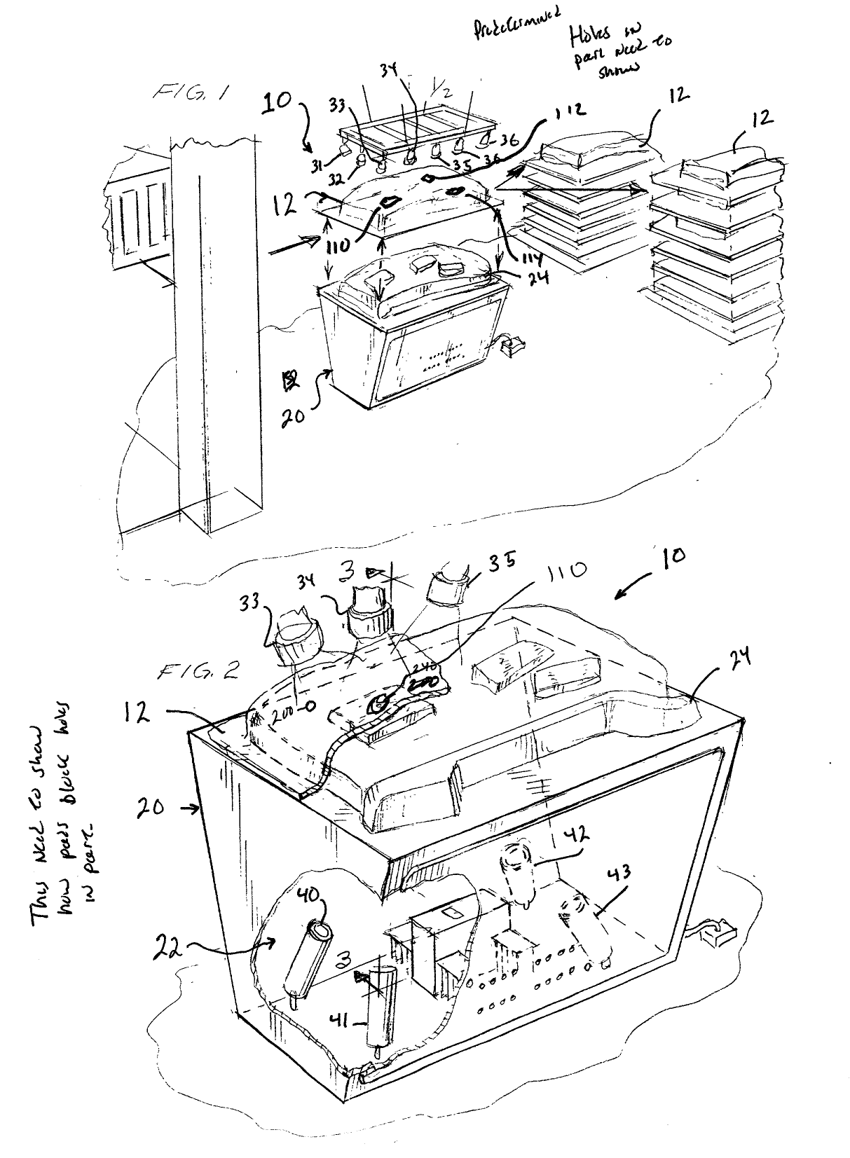

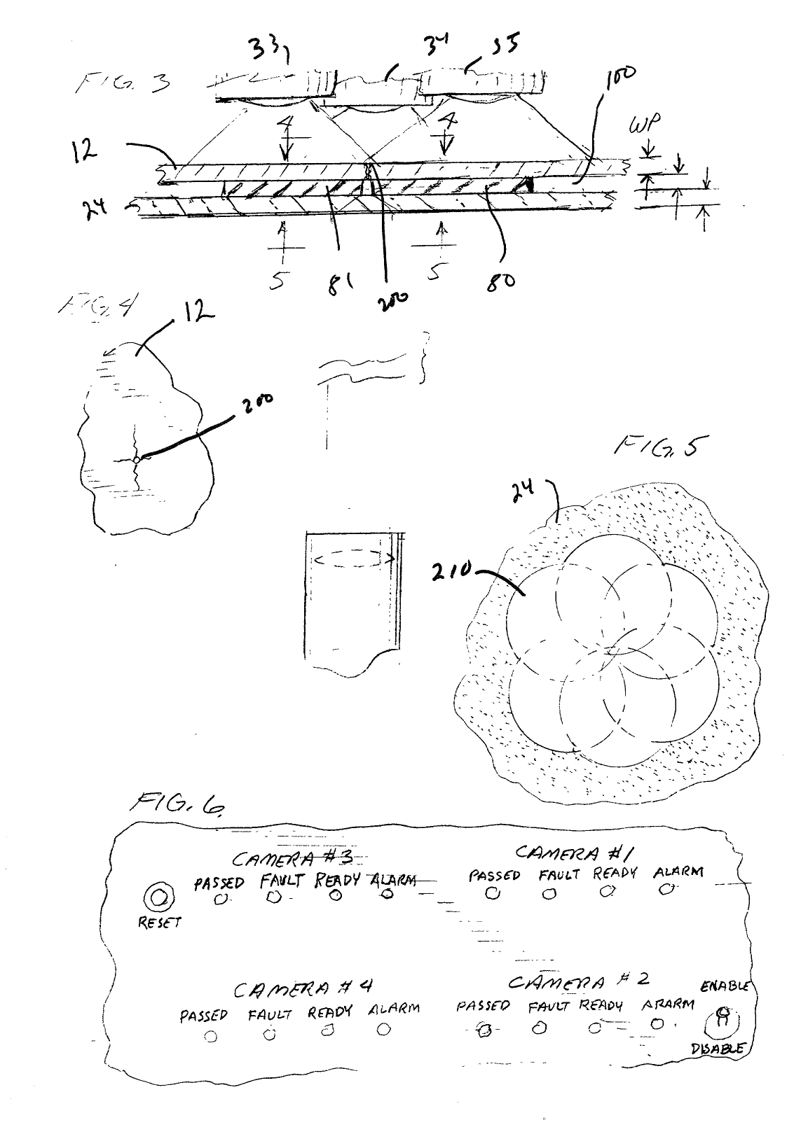

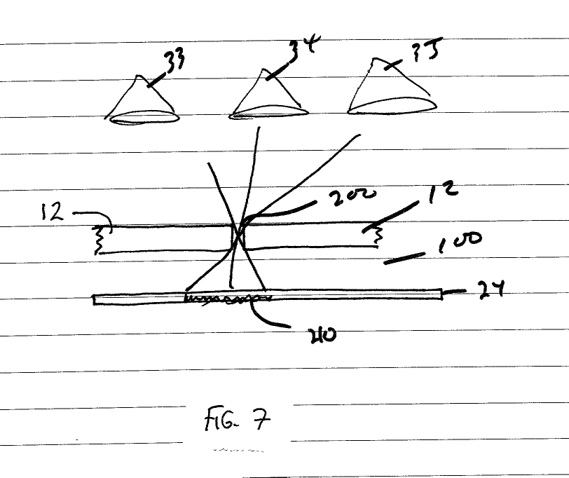

As shown in FIG. 1, the present invention concerns a pin hole detection system 10 for inspecting parts 12, which may be irregularly shaped, stamped metal parts. The system includes a base or buck 20 which defines an enclosed cavity 22 that does not permit or at least restricts the amount of outside light that enters cavity 22. Included in the cavity are detectors 40-43.

Base or buck 20 includes a clear or translucent part support 24. Support 24 may be molded from plastic to fit the contours of part 12. In addition, only portions or predetermined areas of support 24 may be clear or translucent. Alternately, the support 24 may further be configured to define a plurality of contact points, 50-53, as well as others not shown, which engage part 12. This permits the support to positively retain part 12 on the support to inhibit movement of the part in a number of different directions. This also permits the support to function as a reference guide that allows an operator to quickly and easily mount the part onto the device for transport within the conveyor system. The support may be made by vacuum forming. However, support 24 may be planar in nature as well.

As shown in FIG. 2, housed within base 20 are a plurality of sensors 40-43 and the associated electronics 100 used in connection with sensors 40-43. These are used to detect the presence of light which passes through imperfection 200. This may be done without the use of support 24. Alternately, as discussed below, the light may first illuminate support 24 prior to detection.

Also provided are a plurality of light sources 33-35 which may be hung above the system. In addition, pads 80-82 are provided which assist in holding part 12 in a spaced apart relationship with respect to support 24 to form gap 100.

In use, a part or piece to be inspected is placed onto support 24, which is arranged so as to create gap 100 and to positively control and retain the part through multiple contact points such as 50-52. Gap 100 does not necessarily need to exist entirely between the support and part. It can also exist at preselected or predetermined areas. Nor is it needed at all in some situations, especially in instances where a support is not used at all. However, pads 80-82 may be positioned so as to block any predetermined holes or openings 110, 112, and 114 in the part. The arrangement between part 12 and support 24 should be such that no light should reach support 24 in the areas covered by the part when the part is properly arranged on the support and in acceptable working order.

Once part 12 is positioned over support 24, the light source is activated. The activation of a light source will result in light passing through imperfection 200. This results in an illumination area or pattern 210 on support 24 that indicates that the part has an imperfection. Of course, support 24 may be used as the sensor as well to indicate the presence of light. Alternately, the support may not be illuminated at all with the light passing through the part and being detected by the sensors by either direct contact or through reflection in the cavity.

Using a plurality of light sources cause multiple beams of light to pass through the imperfection at a variety of angles. Configuring the device in this manner results in an illumination area or pattern 210 that is larger in area than the size of the actual imperfection itself. This makes it easier for the sensors or other equipment to detect that light has passed through the part and then onto the selected area of the support which is clear or translucent. Creating a larger illumination area further eliminates the need to use a focusing lens with the system. Gap 100 also assists in creating the larger illumination area 210 as is illustrated in FIG. 6. In this manner, parts such as stamped pieces of metal may be individually inspected quickly and efficiently for small imperfections.

While the preferred embodiments of the present invention have been illustrated and described, it will be understood by those of ordinary skill in the art that changes and other modifications can be made without departing from the invention in its broader aspects. Various features of the present invention are set forth in the following claims.

What is claimed is:

1. A part detection system comprising:
a base defining a cavity;
a support which operates in conjunction with said base, said support retains a part thereon in a spaced apart relationship;
a plurality of light sources positioned adjacent said support so as to illuminate a prt located on said support;
a light transparent area on said support; and
sensors located in said base for detecting light passing through said support from said light source when an imperfection is present in a part positioned on said base.
